(19) United States
(12) Patent Application Publication
(10) Pub. No.: US 2009/0307283 A1
(43) Pub. Date: Dec. 10, 2009

(54) DYNAMIC BACKUP WINDOW OPTIMIZATION APPARATUS AND METHOD

(75) Inventors: Douglas L. Lehr, Tucson, AZ (US); Franklin E. McCune, Tucson, AZ (US); David C. Reed, Tucson, AZ (US); Max D. Smith, Tucson, AZ (US)

Correspondence Address: IBM CORP. (TUCSON), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/132,949

(22) Filed: Jun. 4, 2008

(51) Int. Cl. G06F 12/16

(52) U.S. Cl. 707/204; 707/E17.044; 711/E12.103

(57) ABSTRACT

An apparatus, method, and computer program product to dynamically optimize a backup window for a data store is disclosed herein. In one embodiment, an apparatus may include tracking module, a determination module, a window module, and a backup module. The tracking module may track usage of a data store over a period of time. A determination module may determine a period of minimal usage associated with the data store. The determination module may also determine an expected backup duration for the data store. Once the expected backup duration and period of minimal usage are known, a window module may calculate an optimal backup window for the data store. A backup module may then backup the data store during the backup window.

### BACKGROUND

1. Field of the Invention

This invention relates to data storage management, and more particularly to apparatus and methods for optimizing the backup of data.

2. Background of the Invention

Data is increasingly one of an organization's most valuable assets. Accordingly, it is paramount that an organization regularly back up its data, particularly its business-critical data. Statistics show that a high percentage of organizations, as high as fifty percent, are unable to recover from an event of significant data loss, regardless of whether the loss is the result of a virus, data corruption, physical disaster, software or hardware failure, human error, or the like. At the very least, significant data loss can result in lost income, missed business opportunities, and/or substantial legal liability. Accordingly, it is important that an organization implement adequate backup policies and procedures to prevent such losses from occurring.

Many storage management, backup, and/or disaster recovery products enable an end user to specify a type of backup to be performed (e.g., a full, differential, or incremental backup) as well as the frequency (e.g., daily, weekly, monthly) of the backup, and a time of day, week, or month that a backup is to be performed. An end user may attempt to identify periods of off-peak or lower data usage so that a data store may be scheduled for backup during these periods. This will help ensure that access to the data store or the speed of access is not degraded significantly. Once these parameters are set, the backup procedures will generally run according to the specified parameters unless modified by the end user. Often, these parameters are set and rarely adjusted by the end user.

Conventional techniques for scheduling backups have several disadvantages. For example, data usage or other characteristics (e.g., size) of a data store may change over time, causing the initial backup parameters or settings to become less ideal over time. This may require an end user to constantly reassess the usage and characteristics of a data store to ensure that the backup settings are ideal or as close to ideal as possible. Another disadvantage of conventional techniques is that backing up a group of data stores (e.g., a group of files, databases, volumes, or the like.) may not be ideal for all data stores involved.

In view of the foregoing, what is needed is an improved apparatus and method to optimize backup windows for backing up data stores. Ideally, such an apparatus and method would be able to dynamically modify a backup window to correspond to changes in data usage or other characteristics of a data store over time. Further needed are apparatus and methods to back up groups of data stores in a way that is more optimal for each data store involved.

### SUMMARY

The invention has been developed in response to the present state of the art and, in particular, in response to the problems and needs in the art that have not yet been fully solved by currently available apparatus and methods. Accordingly, the invention has been developed to provide improved apparatus and methods for dynamically optimizing backup windows for data stores over time. The features and advantages of the invention will become more fully apparent from the following description and appended claims, or may be learned by practice of the invention as set forth hereinafter.

Consistent with the foregoing, an apparatus to dynamically optimize a backup window for a data store is disclosed herein. According to one embodiment of the invention, such an apparatus may include a tracking module, a determination module, a window module, and a backup module. The tracking module may track the usage of a data store over a period of time, such as a period of days, weeks, or months. A determination module may determine a period of minimal usage associated with the data store. The determination module may also determine an expected backup duration for the data store. Once the expected backup duration and period of minimal usage are known, a window module may calculate an optimal backup window for the data store. A backup module may then backup the data store during the backup window.

In another embodiment of the invention, a method to dynamically optimize a backup window for a data store may include tracking usage of a data store over a period of time. The method may further include determining a period of minimal usage associated with the data store, and determining an expected backup duration for the data store. The method may further include calculating an optimal backup window based on the expected backup duration and the period of minimal usage, and backing up the data store during the backup window.

In yet another embodiment of the invention, a computer program product is disclosed for dynamically optimizing a backup window for a data store. The computer program may include a computer-usable medium having computer-usable program code embodied therein. In one embodiment, the computer-usable program code may include code to track usage of a data store over a period of time, code to determine a period of minimal usage associated with the data store, and code to determine an expected backup duration for the data store. The computer-usable program code may also include code to calculate an optimal backup window based on the expected backup duration and the period of minimal usage, and code to back up the data store during the backup window.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram of one embodiment of a system for dynamically optimizing a backup window for a data store;

FIG. 2 is a flow chart showing one embodiment of a method in accordance with the invention;

FIG. 3 is a flow chart showing another embodiment of a method in accordance with the invention;

FIG. 4 is a graph showing one embodiment of a technique for determining a backup window for a data store;

FIG. 5 is a graph showing another embodiment of a technique for determining a backup window for a data store; and

FIG. 6 is a high-level block diagram of one embodiment of a backup window optimization module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

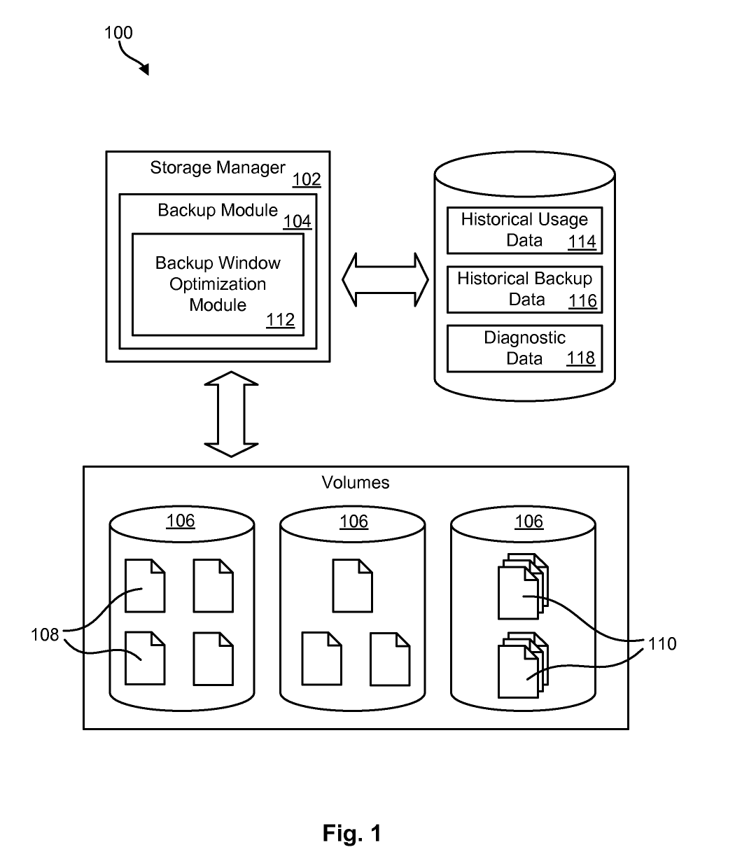

Referring to FIG. 1, in selected embodiments, an apparatus 100 or system 100 for dynamically optimizing a backup window for a data store may include a storage manager 102 to centrally manage a data store, including, for example, backing up and archiving data stores, providing disaster recovery services, or the like. Examples of storage managers 102 may include, for example, Data Facility Hierarchical Storage Manager (DFHSM), Data Facility Data Set Services (DFDSS), and Tivoli Storage Manager (TSM), to name just a few. The storage manager 102 may also include any analogous or similarly used products.

In selected embodiments, the storage manager 102 may include a backup module 104 to back up (or copy) a data store onto a medium such as a hard disk, magnetic tape, or the like. A “data store,” for purposes of this description, may include a volume 106, a data set 108, a file 108, or aggregates 110 or combinations thereof. Aggregates 110 may include, for example, groupings of data sets 108 or files 108, which may be backed up together as a single entity. A backup copy of any or all of these data stores may be used to restore the data in the event the data is lost or corrupted. As previously mentioned, many conventional storage manager products may allow an administrator to schedule backups at certain times of day, week, months, or the like. Once the times are set, they are fixed and rarely adjusted. Such a fixed schedule may be less than ideal because usage of the data or the data itself may change over time.

In selected embodiments in accordance with the invention, a backup window optimization module 112 may be provided to dynamically optimize a backup window for a data store or a group of data stores. Such an optimization module 112 may be integrated into the storage manager 102 or another product, or be provided as a stand-alone product. As will be explained in more detail hereafter, the optimization module 112 may compute peak and off-peak periods of data usage in order to dynamically optimize a backup window to correspond to these periods. For the purpose of this description, the term “usage” may refer to any access to a data store, including reads or writes thereto. As will be explained in more detail hereafter, when computing the optimal backup window, the optimization module 112 may examine historical usage data 114, historical backup data 116, or the like. As will also be explained, the optimization module 112 may also gather and examine various types of diagnostic data 118 in the event a backup does not complete within a designated backup window.

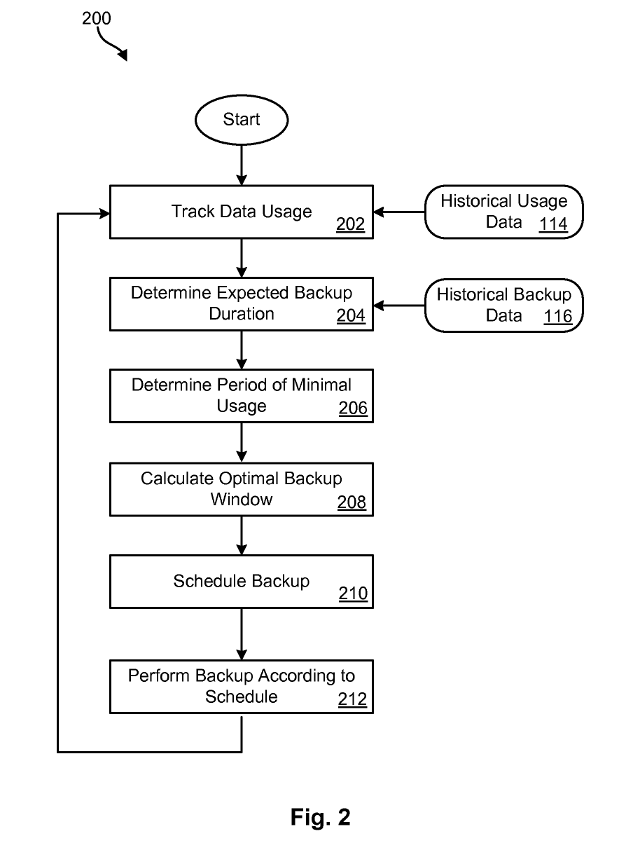

Referring to FIG. 2, in selected embodiments, a method 200 for dynamically optimizing a backup window for a data store may include initially tracking 202 data usage over a period of time. The period may be days, weeks, months, or the like. In certain embodiments, tracking 202 may include examining historical usage data 114, such as System Management Facilities (SMF) records (where the method 200 is used in conjunction with IBM's z/OS mainframe computers), or other analogous logs or records of data accesses where other systems or computers are used. Such records may provide a measure of the usage for a data store and how the usage varies over time.

The method 200 may then determine 204 the expected backup duration for the data store that is to be backed up. In certain embodiments, the size of the data store may be examined to provide a general estimate of the expected backup duration. In other embodiments, historical backup data 116 may be examined to provide an estimate. Historical backup data 116, for instance, may include records of previous backups, which may include the times and resources required to perform the backups.

In selected embodiments, trends in previous backup durations may be examined when determining 204 the expected backup duration. For example, if a data store is growing over time, the time required to backup the data may also increase over time. Thus, the method 200 may consider such trends when determining 204 the expected backup duration. In certain embodiments, greater weight may be given to more recent backups when determining 204 the expected backup duration, since they are temporally closer in proximity.

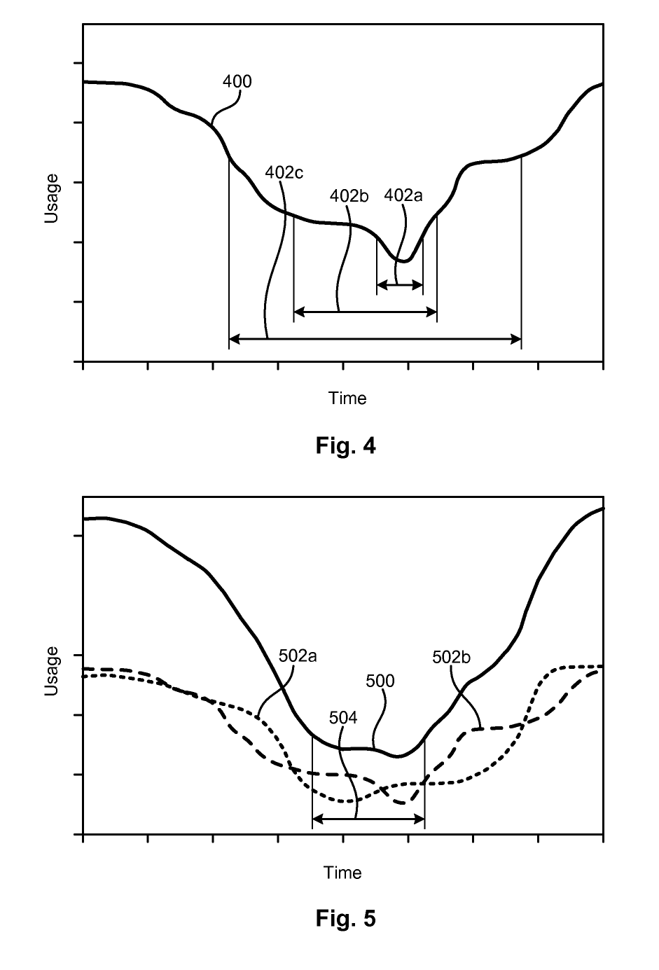

Once the expected backup duration has been determined 204, the method 200 may determine 206 a period of minimal usage associated with the expected backup duration. It is during the period of minimal usage that the backup is ideally performed, since it will likely have the smallest effect on data access or access speeds. Using this period of minimal usage, the method 200 may then calculate 208 the optimal backup window. Various techniques may be used to calculate the period of minimal usage and the optimal backup window, two of which are explained in more detail in association with FIGS. 4 and 5. Once the optimal backup window is determined 208, the method 200 may include scheduling 210 a backup to correspond with the optimal backup window. The method 200 may then perform 212 the backup according to the schedule.

Once the backup is performed 212, the method 200 may repeat the method steps previously described. By continually repeating the method 200, the optimal backup window may be dynamically modified to reflect changes in the data store, changes in the usage of the data store, or the like.

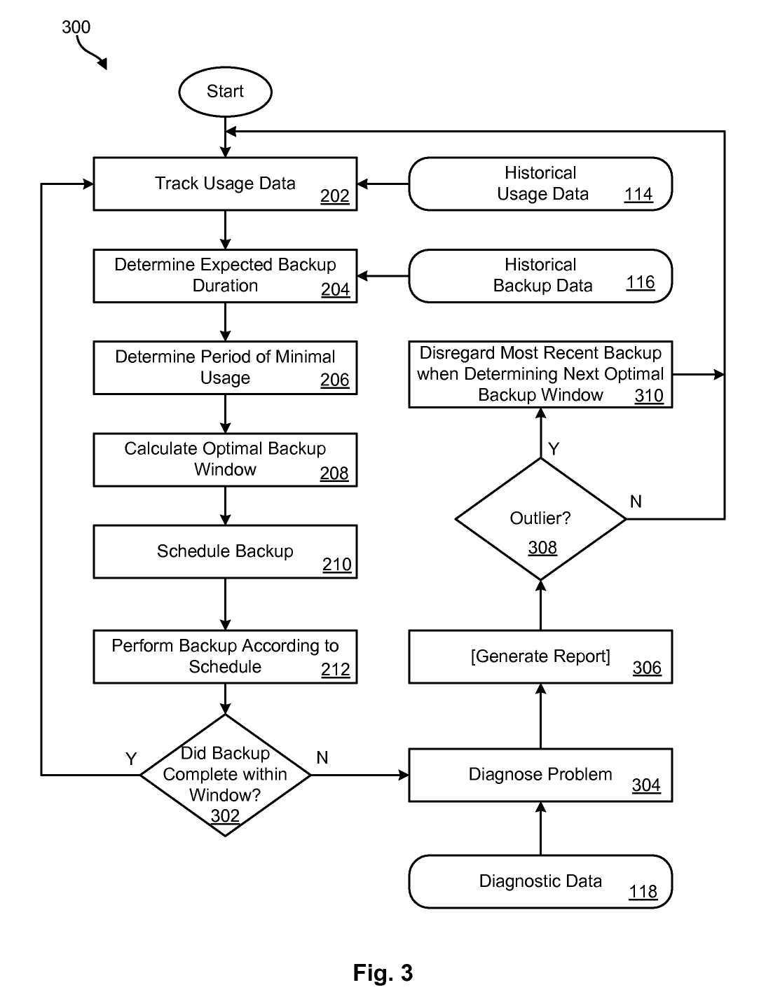

Referring to FIG. 3, in certain cases, an actual backup duration may exceed the expected backup duration. This is undesirable as it may cause the backup duration to extend into periods of high or significant data usage, potentially interfering with or slowing access to the data. Thus, in certain embodiments, a method 300 in accordance with the invention may include various steps to diagnose why the actual backup duration exceeded the expected backup duration. These steps may be used to determine if the backup was an outlier or, alternatively, the optimal backup window should be modified to reflect the extended backup duration.

For example, in selected embodiments, a method 300 may include the process steps 202, 204, 206, 208, 210, 212 previously discussed herein. In addition, a decision step 302 may be provided to determine whether the backup completed within the backup window. If the backup was completed within the window, the method 300 may proceed back to the tracking step 202. However, if the backup was not completed within the backup window, the method 300 may diagnose 304 the problem. In selected embodiments, this may include gathering diagnostic data 118, which may, for instance, include access records or logs (e.g., SMF records), contention reports, hardware utilization reports, or the like. This information may be used to determine if the extended duration of the backup was a one-time event due to a hardware or software error, the unavailability of resources, high data usage during the backup period, or the like. In such a case, the event may be considered an outlier that would not warrant changing the optimal backup window. On the other hand, if the extended duration of the backup was due, for instance, to the data store increasing in size, such a situation may warrant changing the optimal backup window.

In selected embodiments, the method 300 may generate 306 a report, which may be provided to an end user in an effort to explain the extended duration of the backup. Such a report, for example, may contain information gathered from access records or logs, contention reports, or hardware utilization reports as previously discussed herein. This may allow the end user to make an educated decision as whether the extended backup duration was due to a one-time event or was due to factors that would warrant changing the optimal backup window. In other embodiments, the backup optimization module 112 may be configured to make this decision internally, particularly in situations where the reason is evident and could be recognized and addressed by hardware and/or software.

If the end user (or the backup window optimization module 112) determines 308 that the extended backup duration is an outlier, the method 300 may be configured to disregard the most recent backup when determining the next optimal backup window. Similarly, if the end user or backup window optimization module 112 determines 308 that the extended backup duration is not an outlier, the method 300 may proceed back to the top of the method 300. In such a case, the extended backup duration will be taken into account when determining the next optimal backup window.

FIG. 4 shows one embodiment of a technique for calculating the optimal backup window. In certain embodiments, the technique may include initially tracking data usage for a data store over a period of time. For example, a curve 400 may represent the data usage for a data store over a period of time, which may include a period of days, weeks, months, or the like. The expected backup duration for a data store may then be estimated using historical backup data, trend analysis, or characteristics of the data itself (e.g., the size of the data). The optimal backup window may then be calculated by aligning the estimated backup duration with a corresponding period of minimal usage. For example, an expected backup duration 402a may provide a first window, an expected backup duration 402b may provide a second window, and an expected backup duration 402c may provide a third window, as determined by a period of minimal usage for each backup duration.

FIG. 5 shows another embodiment of a technique for calculating the optimal backup window for a data store containing multiple files or data sets (e.g., an aggregate). In this example, the curves 502a, 502b represent the usage characteristics for two different files or data sets over a period of time. If the files or data sets are backed up as a group, computing the optimal backup window may include calculating the usage characteristics for the group. In this example, the two curves 502a, 502b may be added together to create an aggregate curve 500, showing the usage characteristics for the group. Once the expected backup duration 504 is determined for the group, an optimal backup window may be calculated for the group by aligning the expected backup duration 504 with the period of minimal usage on the curve 500. The techniques illustrated in FIGS. 4 and 5 are presented only by way of example and are not intended to be limiting.

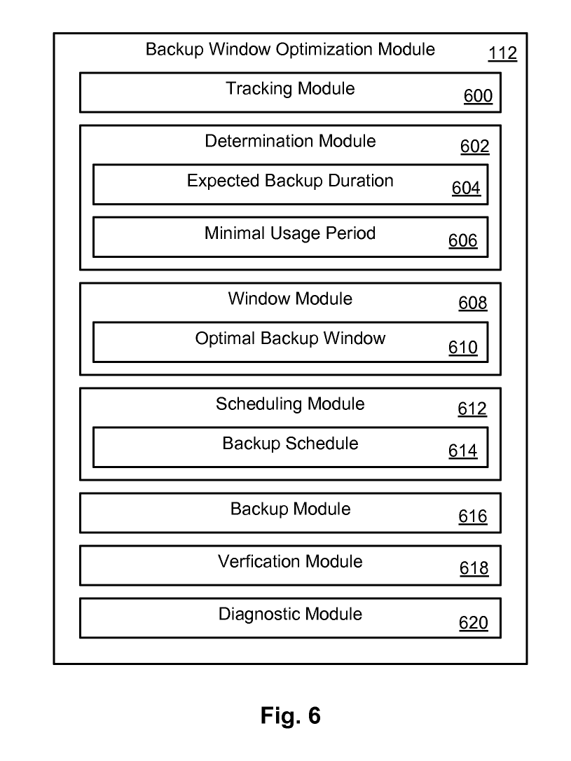

Referring to FIG. 6, in selected embodiments, a backup window optimization module 112 may be incorporated into a system, apparatus, or computer program product in accordance with the invention. Such a backup window optimization module 112 may include one or more of a tracking module 600, a determination module 602, a window module 608, a scheduling module 612, a backup module 616, a verification module 618, and a diagnostic module 620.

The tracking module 600 may track data usage for a data store over a period of time. In certain embodiments, the tracking module 600 may use SMF records or other data access logs or records to track the data usage, as previously discussed herein.

A determination module 602 may determine an expected backup duration 604 for the data store. In certain embodiments, the determination module 602 may consider the size of the data store or examine historical backup data to estimate the expected backup duration 604. In selected embodiments, trends in previous backup durations may be considered when estimating the expected backup duration. Once the expected backup duration has been determined, the determination module 602 may determine a minimal usage period 606 associated with the expected backup duration 604. This minimal usage period 606, for example, may be calculated using either of the techniques discussed in association with FIGS. 4 and 5.

Using this minimal usage period, a window module 608 may calculate the optimal backup window 610, which may include start and end times, including the day, week, or month the backup is to be performed. Once the optimal backup window 610 is determined, a scheduling module 612 may schedule the backup to occur within the optimal backup window 610. A backup module 616 may then perform the backup according to the schedule 614.

In certain embodiments, a verification module 618 may determine whether the backup completed within the backup window. If the backup did not complete within the backup window, a diagnostic module 620 may determine what factors may have caused the backup to exceed the backup window. In certain embodiments, the diagnostic module 620 may make this determination based on access records or logs, contention reports, hardware utilization reports, or the like. Using this information, the diagnostic module 620 may determine if the extended backup duration was a one-time event.

In selected embodiments, the diagnostic module 620 may generate a report containing information that may explain the cause of the extended backup duration. This may allow an end user to make an educated decision as to whether the extended backup duration was a one-time event or was due to factors that would warrant changing the optimal backup window. If the diagnostic module 620 determines (either internally or from user input) that an extended backup duration is an outlier, the diagnostic module 620 may disregard the most recent backup when determining the next optimal backup window.

Although particular reference is made herein to apparatus and methods for optimizing a backup window, the principles discussed here may be applicable to virtually any situation where data is moved or copied from one place to another. For example, the apparatus and methods discussed herein may be equally applicable to tier migration. That is, the apparatus and methods discussed herein may be used to determine an optimal window for migrating data from one place to another. Such an operation may be similar or identical to a backup operation except that the original data may be deleted after it has been copied. Thus, the term “backup” is used broadly herein to refer to any situation where data is moved or copied from one place to another.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. An apparatus to dynamically optimize a backup window for a data store, the apparatus comprising:
a tracking module to track usage of a data store over a period of time;
a determination module to determine a period of minimal usage associated with the data store;
the determination module further configured to determine an expected backup duration for the data store;
a window module to calculate an optimal backup window based on the expected backup duration and the period of minimal usage; and
a backup module to backup the data store during the backup window.

2. The apparatus of claim 1, further comprising a verification module to determine whether the backup was completed within the backup window.

3. The apparatus of claim 2, further comprising a diagnostic module to gather diagnostic information if the backup exceeds the backup window.

4. The apparatus of claim 3, wherein the diagnostic module further analyzes the diagnostic information to determine why the backup exceeded the backup window.

5. The apparatus of claim 4, wherein the diagnostic module generates a report for an end user.

6. The apparatus of claim 3, wherein the diagnostic information comprises at least one of access records, contention reports, and hardware utilization reports.

7. The apparatus of claim 1, wherein the data store comprises at least one of a data set, a file, a volume, aggregates thereof, and combinations thereof.

8. The apparatus of claim 1, wherein the determination module determines the expected backup duration by analyzing a history of backup durations for the data store.

9. The apparatus of claim 1, wherein the tracking module tracks usage by monitoring access records.

10. The apparatus of claim 1, further comprising a schedule module to schedule a backup of the data store during the backup window.

11. A method to dynamically optimize a backup window for a data store, the method comprising:
tracking usage of a data store over a period of time;
determining a period of minimal usage associated with the data store;
determining an expected backup duration for the data store;
calculating an optimal backup window based on the expected backup duration and the period of minimal usage; and
backing up the data store during the backup window.

12. The method of claim 11, further comprising verifying whether the backup was completed within the backup window.

13. The method of claim 12, further comprising gathering diagnostic information if the backup exceeds the backup window.

14. The method of claim 13, further comprising analyzing the diagnostic information to determine why the backup exceeded the backup window.

15. The method of claim 14, further comprising generating a report for an end user.

16. The method of claim 13, wherein the diagnostic information comprises at least one of access records, contention reports, and hardware utilization reports.

17. The method of claim 11, wherein the data store comprises at least one of a data set, a file, a volume, aggregates thereof, and combinations thereof.

18. A computer program product for dynamically optimizing a backup window for a data store, the computer program product comprising:
a computer-usable medium having computer-usable program code embodied therein, the computer-usable program code comprising:
computer-usable program code to track usage of a data store over a period of time;
computer-usable program code to determine a period of minimal usage associated with the data store;
computer-usable program code to determine an expected backup duration for the data store;
computer-usable program code to calculate an optimal backup window based on the expected backup duration and the period of minimal usage; and
computer-usable program code to back up the data store during the backup window.

19. The computer program product of claim 18, further comprising computer-usable program code to verify whether the backup was completed within the backup window.

20. The computer-program product of claim 19, further comprising computer-usable program code to gather diagnostic information if the backup exceeds the backup window.

21. The computer-program product of claim 20, further comprising computer-usable program code to analyze the diagnostic information to determine why the backup exceeded the backup window.

22. The computer-program product of claim 21, further comprising computer-usable program code to generate a report for an end user.

23. The computer-program product of claim 18, further comprising computer-usable program code to analyze a history of backup durations for the data store.

24. The computer-program product of claim 18, wherein the computer-usable program code further comprises computer-usable program code to monitor access records.

25. The computer-program product of claim 18, further comprising computer-usable program code to schedule a backup of the data store during the backup window.
